(19) United States
(12) Patent Application Publication
(10) Pub. No.: US 2017/0034430 A1
(43) Pub. Date: Feb. 2, 2017

(54) VIDEO RECORDING METHOD AND DEVICE

(71) Applicant: Xiaomi Inc., Beijing (CN)

(72) Inventors: Qiang Fu, Beijing (CN); Yang Wang, Beijing (CN); Enxing HOU, Beijing (CN)

(21) Appl. No.: 15/067,193

(22) Filed: Mar. 11, 2016

(30) Foreign Application Priority Data
Jul. 31, 2015 (CN) 201510465309.2

(51) Int. Cl. H04N 5/232; H04N 5/235

(52) U.S. Cl. CPC H04N 5/23219; H04N 5/23203; H04N 5/235

(57) ABSTRACT

A video recording method and device are disclosed. The method includes: acquiring environmental information on a video recording device, the environmental information being used for representing an environmental feature of the video recording device; detecting whether the environmental information satisfies a predefined condition; and if the environmental information satisfies the predefined condition, starting video recording. In the present disclosure, by detecting whether the environmental information on the video recording device satisfies a predefined condition, and starting video recording if the environmental information satisfies the predefined condition, the problem of troublesome video recording process is solved, and the video recording process is simpler and more convenient.

### CROSS-REFERENCE TO RELATED APPLICATIONS

This application is based upon and claims priority to Chinese Patent Application No. 201510465309.2, filed Jul. 31, 2015, the entire contents of which are incorporated herein by reference.

### TECHNICAL FIELD

The present disclosure relates to the field of information technology and, more particularly, to a video recording method and device.

### BACKGROUND

With the development of science and technology, video has become an important communication tool in social networks. Various methods for recording videos and video recording devices emerge in endlessly.

In related art, there is one kind of video recording method, wherein the user operates a video recording device, and when the user finds a scene he wants to capture, he may press a recording button of the video recording device to record a video, and the recorded video may be automatically stored in the video recording device.

### SUMMARY

The embodiments of the present disclosure provide a video recording method and device. The technical solutions are as follows.

According to a first aspect, there is provided a video recording method, including: acquiring environmental information on a video recording device, the environmental information being used for representing an environmental feature of the video recording device; detecting whether the environmental information satisfies a predefined condition; and if the environmental information satisfies the predefined condition, starting to record a video.

According to a second aspect, there is provided a video recording device, including: a processor; and a memory for storing instructions executable by the processor; wherein the processor is configured to: acquire environmental information on a video recording device, the environmental information being used for representing an environmental feature of the video recording device; detect whether the environmental information satisfies a predefined condition; and if the environmental information satisfies the predefined condition, start to record a video.

According to a third aspect of the embodiments of the present disclosure, there is provided a non-transitory readable storage medium including instructions, executable by a processor in an electronic device, for performing a video recording method, the method including: acquiring environmental information on a video recording device, the environmental information being used for representing an environmental feature of the video recording device; detecting whether the environmental information satisfies a predefined condition; and if the environmental information satisfies the predefined condition, starting to record a video.

The technical solutions provided by embodiments of the present disclosure may in part, include the following advantageous effects: by detecting whether the environmental information on the video recording device satisfies a predefined condition, and starting to record a video if the environmental information satisfies the predefined condition, the problem of troublesome video recording process is solved, and the video recording process become simpler and more convenient.

It is to be understood that both the foregoing general description and the following detailed description are exemplary and explanatory only and are not limitations to the invention.

### BRIEF DESCRIPTION OF THE DRAWINGS

The accompanying drawings, which are incorporated in and constitute a part of this specification, illustrate embodiments consistent with the invention and, together with the description, serve to explain the principles of the invention.

FIG. 1 is a flow chart of a video recording method according to one exemplary embodiment of the present disclosure;

FIG. 2A is a flow chart of a video recording method according to another exemplary embodiment of the present disclosure;

FIG. 2B is a flow chart for detecting environmental information in the embodiment shown in FIG. 2A;

FIG. 3A is a flow chart of a video recording method according to another exemplary embodiment of the present disclosure;

FIG. 3B is a flow chart for detecting environmental information in the embodiment shown in FIG. 3A;

FIG. 4A is a flow chart of a video recording method according to another exemplary embodiment of the present disclosure;

FIG. 4B is a flow chart for detecting environmental information in the embodiment shown in FIG. 4A;

FIG. 5A is a block diagram of a video recording device according to one exemplary embodiment of the present disclosure;

FIG. 5B is a block diagram of one detecting module in the embodiment shown in FIG. 5A;

FIG. 5C is a block diagram of another detecting module in the embodiment shown in FIG. 5A;

FIG. 5D is a block diagram of further another detecting module in the embodiment shown in FIG. 5A;

FIG. 5E is a block diagram of a video recording device according to another exemplary embodiment of the present disclosure;

FIG. 5F is a block diagram of a video recording device according to another exemplary embodiment of the present disclosure; and

FIG. 6 is a block diagram of a video recording device according to one exemplary embodiment of the present disclosure.

Specific embodiments in this disclosure have been shown by way of examples in the foregoing drawings and are hereinafter described in detail. The figures and written description are not intended to limit the scope of the inventive concepts in any manner. Rather, they are provided to illustrate the inventive concepts to a person skilled in the art by reference to particular embodiments.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of devices and methods consistent with some aspects related to the invention as recited in the appended claims.

The video recording device involved in respective embodiments of the present disclosure may be an electronic device having a capturing function and environmental information (may include at least one of sound, image, light intensity and position) acquiring function, such as a smart phone, a photographic camera, a video camera and a camera.

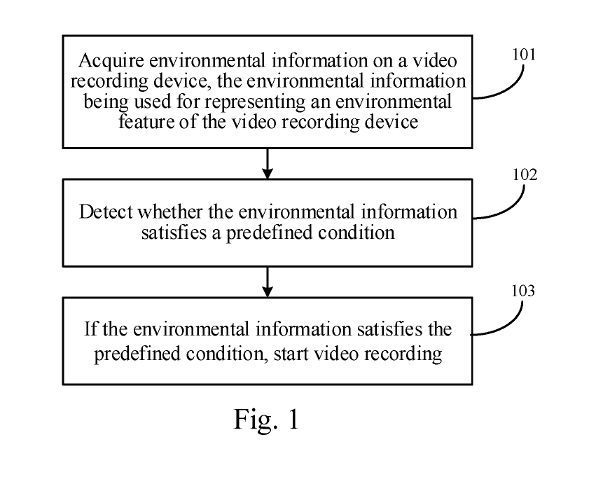

FIG. 1 is a flow chart of a video recording method according to one exemplary embodiment of the present disclosure. The video recording method may be used in a video recording device. The video recording method may include the following steps.

In step 101, environmental information on a video recording device is acquired, and the environmental information is used for representing an environmental feature of the video recording device.

In step 102, whether the environmental information satisfies a predefined condition is detected.

In step 103, if the environmental information satisfies the predefined condition, video recording is started.

In summary, by detecting whether the environmental information on the video recording device satisfies a predefined condition, and starting to record a video if the environmental information satisfies the predefined condition, the video recording method provided by embodiments of the present disclosure solves the problem of troublesome video recording process in the related art, and achieves the effect that the video recording process is simpler and more convenient.

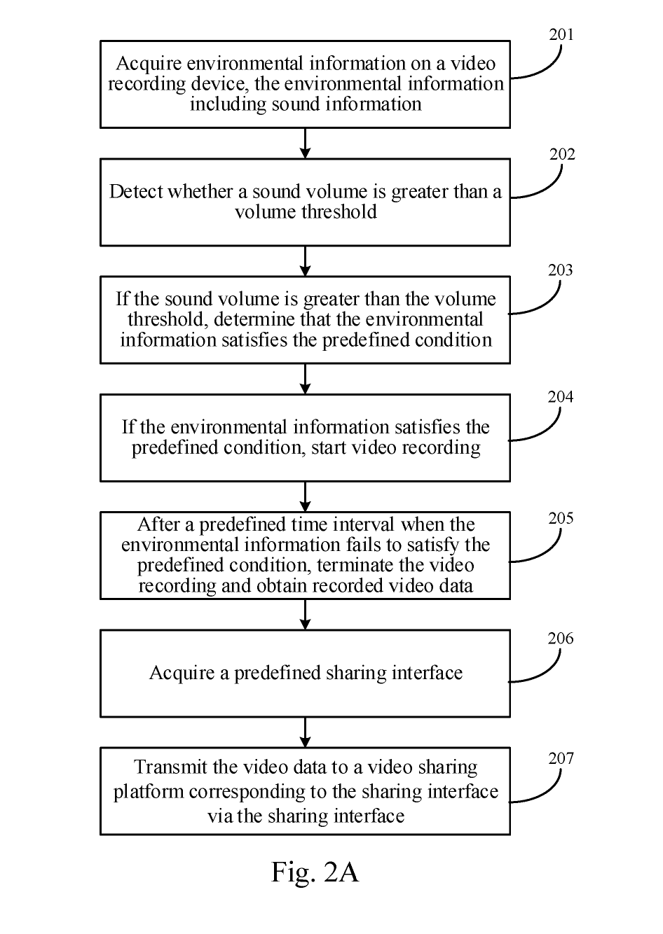

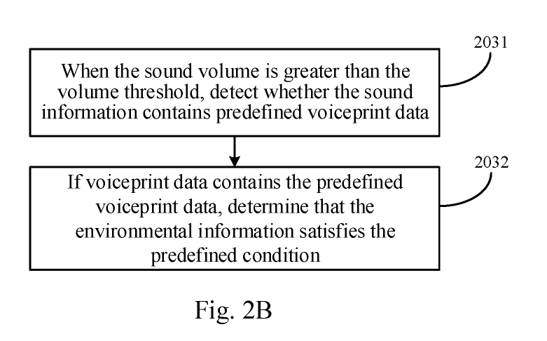

FIG. 2A is a flow chart of a video recording method according to another exemplary embodiment of the present disclosure. The video recording method may be used in a video recording device. The video recording method may include the following steps.

In step 201, environmental information on a video recording device is acquired, and the environmental information includes sound information.

When implementing the video recording method provided by the embodiments of the present disclosure, the video recording device may be in a monitoring state in which the video recording device may acquire video data but does not store the video data. Meanwhile, the video recording device may acquire the environmental information on the video recording device. Optionally, the environmental information contains sound information. Illustratively, a microphone may be provided at the video recording device, and the microphone may acquire the sound information on the video recording device in real time.

In step 202, whether the sound volume is greater than a volume threshold is detected.

After acquiring the surrounding sound information, the video recording device may detect whether the sound volume is greater than a predefined volume threshold, wherein the volume is also called loudness, and the video recording device may determine a magnitude of the volume by an amplitude of the sound, and judge whether the volume is greater than a volume threshold.

In step 203, if a sound volume indicated by the sound information is greater than the volume threshold, it is determined that the environmental information satisfies the predefined condition.

When detecting that the sound volume is larger than the volume threshold, the video recording device may determine that the environmental information satisfies the predefined condition.

In addition, step 203 may further include the following two substeps.

In substep 2031, when the sound volume is larger than the volume threshold, whether the sound information contains predefined voiceprint data is detected.

When detecting that the sound volume is larger than the volume threshold, the video recording device may further detect whether the sound information contains predefined voiceprint data, wherein the voiceprint data is acoustic spectrum data carrying verbal information and being displayed by an electroacoustics instrument, and the data may be used to determine who emits the sound information.

In substep 2032, if the sound information contains the predefined voiceprint data, it is determined that the environmental information satisfies the predefined condition.

When detecting that the sound information contains the predefined voiceprint data, the video recording device may determine that the environmental information satisfies the predefined condition. The predefined voiceprint data may be preset by the user. As an example, the user may set voiceprint data of his family as the predefined voiceprint data in advance. In this way, when the family of the user speaks around the video recording device with a sound volume higher than the volume threshold, the video recording device may acquire the environmental information satisfying the predefined condition.

In step 204, if the environmental information satisfies the predefined condition, video recording is started.

When determining that the environmental information satisfies the predefined condition, the video recording device may start video recording. When recording the video, the video recording device may store the acquired video data. As an example, the video recording device may store the video data into a local storage. That is, when the environmental information on the video recording device satisfies the predefined condition, the video recording device may automatically start the video recording, and the predefined condition may be preset by the user; in this way, the video recording device may automatically start recording of a scene he wants to shoot.

It should be noted that, the video recording method provided by the embodiments of the present disclosure may be used to automatically record a video which the user wishes to record, such as a wonderful scene, for instance a scene when the crowd cheers, or a scene when someone sings an impromptu song, and such scenes happen suddenly, and when the user is in such scenes and wants to record such scenes into a video, the best recording time may be missed after operating the video recording device. However, when using the video recording method provided by the embodiments of the present disclosure, the user may pre-set some predefined conditions (such as a sound is greater than a volume threshold) possibly occur during the wonderful scenes, and the video recording device may monitor whether the ambient environmental information satisfies the predefined condition in real time, and start video recording when the environmental information satisfies the predefined condition.

It should be noted that, the source of the sound information acquired by the video recording device may be not within a shooting range (the shooting range is decided by an orientation of a camera in the video recording device, and an object within the shooting range will appear in the shooting picture of the video recording device) of the video recording device, in this case, the video recording device may not start video recording, or the video recording device may change an orientation of the camera via a steering component, so as to include the sound source into the shooting range and then start the video recording. The video recording device is capable of positioning the sound source by using a microphone array, and turning the camera to face the sound source based on the positioning result, wherein the positioning method may be referred to related art, and which is not elaborated herein.

It should be noted that, prior to this step, the video recording device may also be in an off state in which it only acquires ambient environmental information, and when the environmental information satisfies the predefined condition, the video recording device is turned on and starts video recording.

In step 205, after a predefined time interval when the environmental information fails to satisfy the predefined condition, the video recording is terminated and the recorded video data is obtained.

After a predefined time interval when the environmental information fails to satisfy the predefined condition, the video recording device may terminate the video recording and thus obtain the recorded video data. The predefined time interval may be set by the user in advance. Illustratively, the predefined time interval is 30 seconds. In this case, when a sound volume of the user when singing a song is greater than a volume threshold, the video recording device starts to record a video, at this time, the video recording device may continuously acquire the sound information with a volume greater than the volume threshold, and when the user stops singing (or the singing is ended and the applause of audiences ends), the sound volume detected by the video recording device may be smaller than the volume threshold, i.e., the environmental information fails to satisfy the predefined condition, then after 30 seconds, the video recording device may terminate the video recording and obtain the recorded video data.

In addition, the video recording device may immediately stop the video recording when the environmental information fails to satisfy the predefined condition, which is not limited by the embodiments of the present disclosure.

In step 206, a predefined sharing interface is acquired.

After obtaining the video data, the video recording device may acquire a predefined sharing interface. The sharing interface may include any one of a social platform software, an email and an instant messaging software, and the sharing interface may indicate a sharing method of the video data.

In step 207, the video data is transmitted to a video sharing platform corresponding to the sharing interface via the sharing interface.

After acquiring the predefined sharing interface, the video recording device may transmit the video data to a video sharing platform corresponding to the sharing interface. Illustratively, the video sharing interface may include a server address for video data uploading, the video recording device may upload the video data to a server corresponding to the server address, and the server may be a server of the video sharing platform corresponding to the sharing interface. After that, other users may watch the video data on the video sharing platform.

It should be noted that, the video recording device may also transmit the video data to a video sharing platform corresponding to the sharing interface after a confirmation of the user. Illustratively, the video recording device may establish a wireless or a wired connection with the user terminal. After acquiring the video data, the video recording device may firstly transmit the video data to the user terminal, and a user may watch the video data on the user terminal and edits the video data, then the user may select whether or not to transmit the video data to the video sharing platform.

It should be additionally noted that, according to the video recording method provided by the embodiments of the present disclosure, by starting video recording when a sound volume is greater than a volume threshold, the video recording device is capable of automatically starting to record the scene which the user wants to shoot.

In summary, according to the video recording method provided by embodiments of the present disclosure, by detecting whether the environmental information on the video recording device satisfies a predefined condition, and starting to record a video if the environmental information satisfies the predefined condition, the problem of troublesome video recording process existed in the related art is solved, and the video recording process is simpler and more convenient.

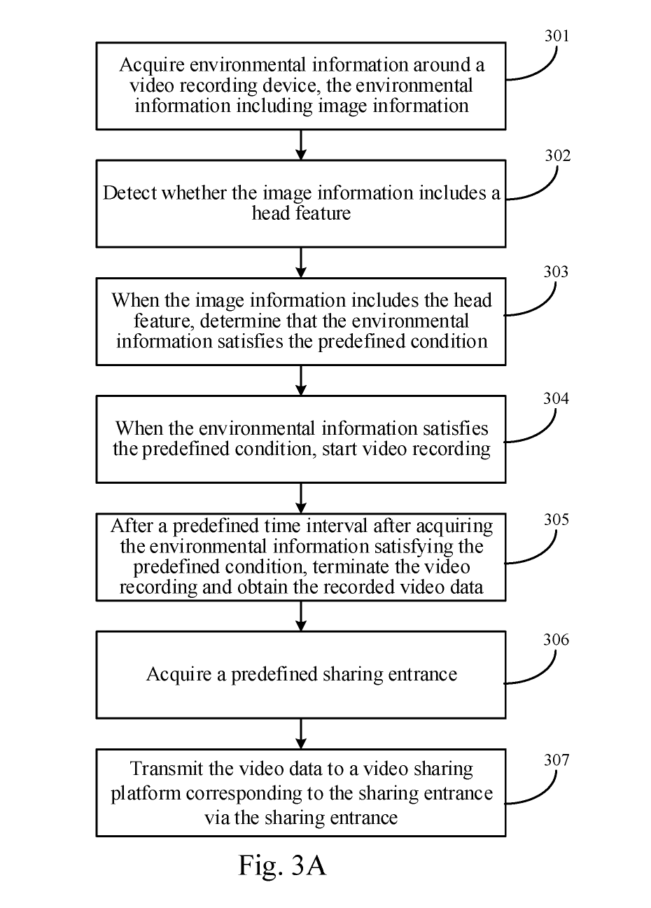

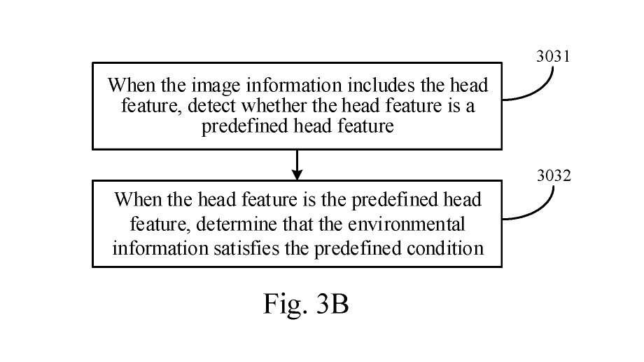

FIG. 3A is a flow chart of a video recording method according to another exemplary embodiment of the present disclosure. The video recording method may be applied to record a video. The video recording method may include the following steps.

In step 301, environmental information on a video recording device is acquired, and the environmental information includes image information.

When implementing the video recording method provided by the embodiments of the present disclosure, the video recording device may be in a monitoring state in which the video recording device may acquire video data but does not store the video data. The video recording device may extract image information from the acquired video data as environmental information.

In step 302, whether the image information includes a head feature is detected.

After acquiring the image information, the video recording device may detect whether the image information contains a head feature by using an image detection technology. The head feature includes, but is not limited to, a facial feature, such as a nose, an eye, a mouth, and also may include the feature such as an ear on the head.

In step 303, when the image information includes the head feature, it is determined that the environmental information satisfies the predefined condition.

When detecting that the image information includes the head feature, the video recording device may determine that the environmental information satisfies the predefined condition. The image information including a head feature may indicate that the picture shot by the video recording device contains a person.

In addition, as shown in FIG. 3B, this step may include the following two substeps.

In substep 3031, when the image information includes the head feature, whether the head feature is a predefined head feature is detected.

When detecting that the image information includes the head feature, the video recording device may detect whether the head feature is a predefined head feature. The predefined head feature may be a head feature of a person desired to be shot which is pre-set by the user, i.e., whether the person in the image information being a person who the user desires to shoot may be judged by detecting whether the head feature is a predefined head feature.

In substep 3032, when the head feature is the predefined head feature, it is determined that the environmental information satisfies the predefined condition.

When detecting that the head feature is the predefined head feature, the video recording device may determine that the environmental information satisfies the predefined condition. That is, when a head feature of the person desired to be shot appears in the shooting picture, the video recording device may determine that the environmental information satisfies the predefined condition.

Illustratively, the shooting direction of the video recording device may be set to aim to a position (such as stage center of a concert) at which a target person (a person who the user wants to shoot) may appear, then after the target person appears at the position, the video recording device may detect the acquired image information, if it detects a head feature, then it continues to detect whether the head feature is the predefined head feature, and determines that the environmental information satisfies the predefined condition when the head feature is the predefined head feature.

It should be noted that, the video recording method provided by the embodiments of the present disclosure may be used to automatically record a video which the user wants to record, such as a scene in which a person whom a certain user wants to shoot appears in the shooting picture of the video recording device, such a scene happens suddenly (for example, the person who the user wants to shoot only appears for several seconds), and when the user wants to record such a scene as a video, the best recording time may be missed after operating the video recording device. However, when using the video recording method provided by the embodiments of the present disclosure, the user may pre-set some predefined conditions (such as the shooting picture contains a head feature of the target person) possibly appeared during the wonderful scenes, and the video recording device may monitor whether the ambient environmental information satisfies the predefined condition in real time.

In step 304, when the environmental information satisfies the predefined condition, the video recording is started.

When determining that the environmental information satisfies the predefined condition, the video recording device may start video recording. When recording a video, the video recording device may store the acquired video data. Illustratively, the video recording device may store the video data into a local storage. That is, when the environmental information on the video recording device satisfies the predefined condition, the video recording device may automatically start the video recording, and the predefined condition may be pre-set by the user; in this way, the video recording device may be capable of automatically starting to record a person whom the user wants to shoot.

In step 305, after a predefined time interval when the environmental information fails to satisfy the predefined condition, the video recording is terminated and the recorded video data is obtained.

After a predefined time interval when the environmental information fails to satisfy the predefined condition, the video recording device may terminate the video recording and obtain the recorded video data, wherein the predefined time interval may be pre-set by the user. Illustratively, the predefined time interval is 30 seconds. When the video recording device detects that a head feature appears in the shooting picture, which indicates that a person appears in the shooting picture, then the video recording device may start video recording, at this time, the video recording device may continuously obtain the image information of the shooting picture and detect whether the image information contains a head feature, when the person in the shooting picture disappears, the head feature may not be detected from the image information acquired by the video recording device, i.e., the environmental information fails to satisfy the predefined condition, then after 30 seconds, the video recording device may terminate the video recording and obtain the recorded video data.

In addition, the video recording device may immediately stop the video recording when the environmental information fails to satisfy the predefined condition, which is not limited by the embodiments of the present disclosure.

In step 306, a predefined sharing interface is acquired.

After obtaining the video data, the video recording device may acquire a predefined sharing interface. The sharing interface may include any one of a social platform software, an email and an instant messaging software, and the sharing interface may indicate a sharing method of the video data.

In step 307, the video data is transmitted to a video sharing platform corresponding to the sharing interface via the sharing interface.

After acquiring the predefined sharing interface, the video recording device may transmit the video data to a video sharing platform corresponding to the sharing interface.

It should be noted that, the video recording device may also transmit the video data to a video sharing platform corresponding to the sharing interface after a confirmation of the user. Illustratively, the video recording device may establish a wireless or a wired connection with the user terminal. After acquiring the video data, the video recording device may firstly transmit the video data to the user terminal, and a user may watch the video data on the user terminal and edits the video data, then the user may select whether or not to transmit the video data to the video sharing platform.

It should be additionally noted that, according to the video recording method provided by the embodiments of the present disclosure, by starting video recording when the image information includes a head feature, the video recording device is capable of automatically starting to record the scene which the user wants to shoot.

In summary, according to the video recording method provided by embodiments of the present disclosure, by detecting whether the environmental information on the video recording device satisfies a predefined condition, and starting to record a video if the environmental information satisfies the predefined condition, the problem of troublesome video recording process existed in the related art is solved, and the video recording process is simpler and more convenient.

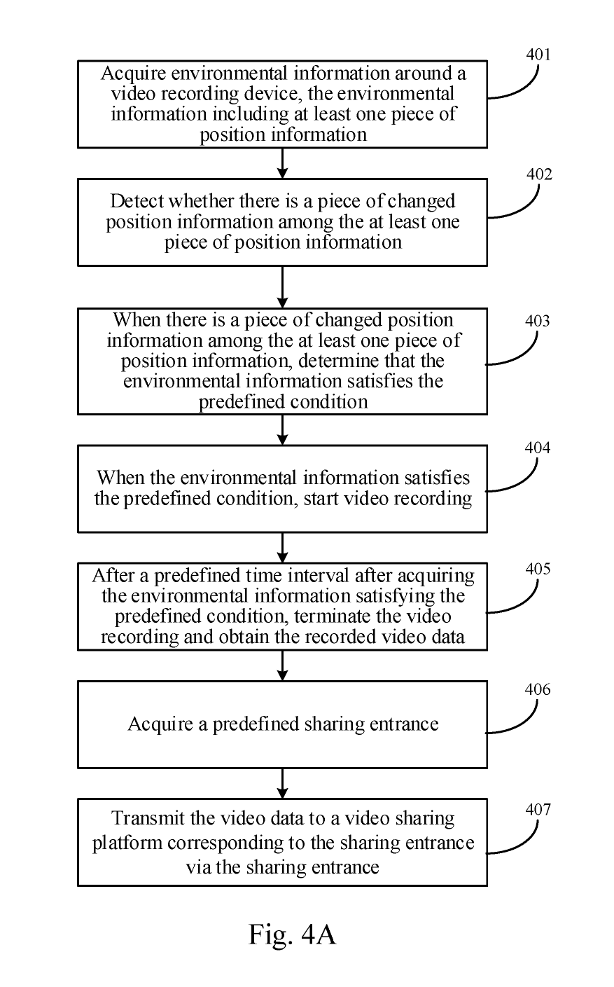

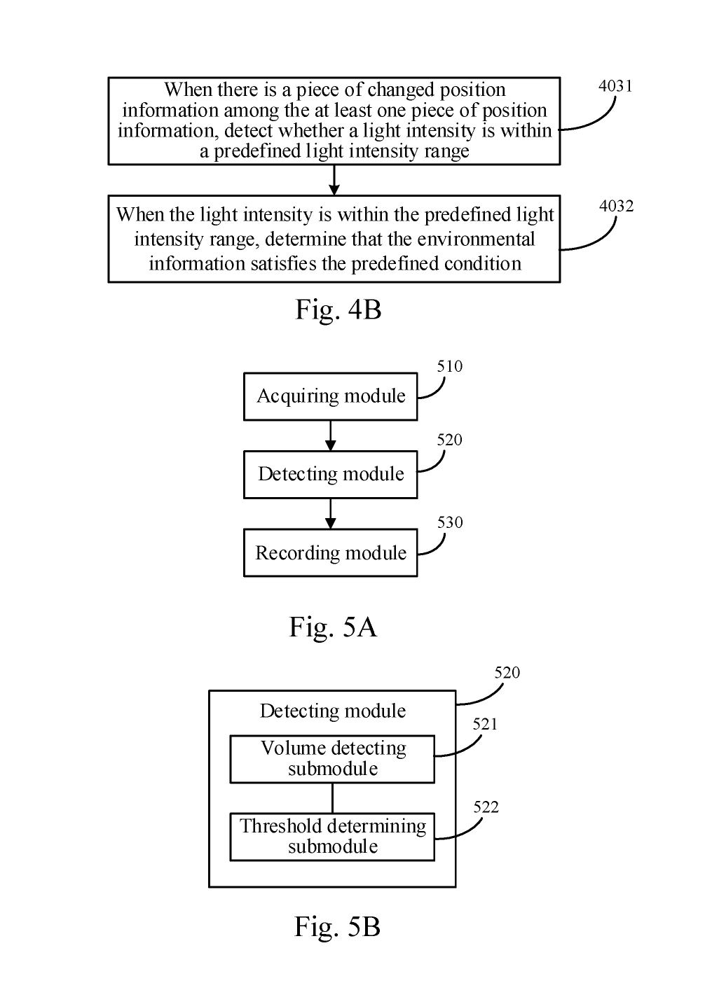

FIG. 4A is a flow chart of a video recording method according to an exemplary embodiment of the present disclosure. The video recording method may be applied to record a video. The video recording method may include the following steps.

In step 401, environmental information on a video recording device is acquired, and the environmental information includes at least one piece of position information.

When implementing the video recording method provided by the embodiments of the present disclosure, the video recording device may be in a monitoring state in which the video recording device may acquire video data but does not store the video data. Meanwhile, the video recording method may also acquire the environmental information on the video recording method, wherein the environmental information may include at least one piece of position information, and each position information may include information on position relative to the video recording device for any object (may include a person, an animal or other movable objects) around the video recording device in a predefined time period. Illustratively, the predefined time period may be 10 seconds, the video recording device may acquire instant position information of a target position (any position around the video recording device) every 5 seconds starting from 0 second, and a total of 3 pieces of instant position information are acquired as the position information of the target position.

It should be noted that, the video recording device may acquire the position information of surrounding positions by using an infrared sensor, a laser sensor or a radar, which is not limited by the embodiments of the present disclosure.

In step 402, whether there is a piece of changed position information among the at least one piece of position information is detected.

After acquiring the at least one piece of position information, the video recording device may detect whether any position information in the at least one piece of position information changes. Illustratively, the position information includes 3 pieces of instant position information of an object within 10 seconds. The video recording device may detect whether the 3 pieces of instant position information are same or whether there is a big difference among the 3 pieces of instant position information. If the 3 pieces of instant position information are not consistent entirely, or are very different, then it is judged that the position information corresponding to the 3 pieces of instant position information is the changed position information.

In step 403, when there is changed position information among the at least one piece of position information, it is determined that the environmental information satisfies the predefined condition.

When any of the position information in the at least one piece of the position information changes, the video recording device may determine that the environmental information satisfies the predefined condition. The changed position information indicates that there is a movable object around the video recording device, and at this time, the video recording device may determine that the environmental information satisfies the predefined condition.

Alternatively, the environmental information further includes a light intensity, and this step may include the following two substeps.

In substep 4031, when there is a piece of changed position information among the at least one piece of position information, whether the light intensity is within a predefined light intensity range is detected.

When detecting that there is a piece of changed position information among the at least one piece of position information, the video recording device may detect whether the light intensity is within a predefined light intensity range. The light intensity may also be called as luminous intensity, and its unit is candela. The user may pre-set a predefined light intensity range, and the predefined light intensity range may be a range suitable for video recording. The video recording device may acquire a light intensity of the ambient environment by using a light intensity sensor.

In substep 4032, when the light intensity is within the predefined light intensity range, it is determined that the environmental information satisfies the predefined condition.

When detecting that the light intensity is within the predefined light intensity range, the video recording device determines that the environmental information satisfies the predefined condition. For scenes with too strong light intensity or too weak light intensity, it is difficult to record a clear video, or the recorded video is very difficult to be viewed. Thus, the case that a recorded video which cannot be viewed clearly may be avoided by detecting whether the light intensity around the video recording device is in a predefined light intensity range during video recording, which improves user experience.

In step 404, when the environmental information satisfies the predefined condition, a video recording is started.

When determining that the environmental information satisfies the predefined condition, the video recording device may start video recording. When recording a video, the video recording device may store the acquired video data. Illustratively, the video recording device may store the video data into a local storage. That is, when the environmental information on the video recording device satisfies the predefined condition, the video recording device may automatically start the video recording, and the predefined condition may be preset by the user; in this way, the video recording device may automatically start recording of a scene which he wants to shoot.

It should be noted that, the video recording method provided by the embodiments of the present disclosure may be used to automatically record a video which the user wishes to record, such as a wonderful scene, for instance a scene when someone is dancing or a scene of kungfu performance. When using the video recording method provided by the embodiments of the present disclosure, the user may pre-set some predefined conditions (such as there is a moving object) possibly occur during the wonderful scenes, and the video recording device may monitor whether the ambient environmental information satisfies the predefined condition in real time, and start video recording when the environmental information satisfies the predefined condition.

It should be noted that, the object corresponding to the changed position information acquired by the video recording device may be not within a shooting range (the shooting range is decided by an orientation of a camera in the video recording device, and an object within the shooting range will appear in the shooting picture of the video recording device) of the video recording device, in this case, the video recording device may not start the video recording, or the video recording device may change an orientation of the camera via a steering component, so as to include the moving object into the shooting range and then start the video recording. The video recording device is capable of controlling the camera to turn to the moving object by using the position information.

It should be noted that, prior to this step, the video recording device may also be in an off state in which it only acquire ambient environmental information, and when the environmental information satisfies the predefined condition, the video recording device is turned on and starts video recording.

In step 405, after a predefined time interval when the environmental information fails to satisfy the predefined condition, the video recording is terminated and the recorded video data is obtained.

After a predefined time interval when the environmental information fails to satisfy the predefined condition, the video recording device may terminate the video recording the video and thus obtain the recorded video data. The predefined time interval may be set by the user in advance. Illustratively, the predefined time interval is 30 seconds. When a user is dancing, his position relative to the video recording device will change. During the video recording time, the video recording device may detect continuous changing position information. When the user stops dancing (or the user leaves the shooting range of the video shooting device), the video recording device no longer acquires the changed position information, i.e., the environmental information fails to satisfy the predefined condition, then after 30 seconds, the video recording device may terminate the video recording and obtain the recorded video data.

In addition, the video recording device may immediately stop the video recording when the environmental information fails to satisfy the predefined condition, which is not limited by the embodiments of the present disclosure.

In step 406, a predefined sharing interface is acquired.

After obtaining the video data, the video recording device may acquire a predefined sharing interface. The sharing interface may include any one of a social platform software, an email and an instant messaging software, and the sharing interface may indicate a sharing method of the video data.

In step 407, the video data is transmitted to a video sharing platform corresponding to the sharing interface via the sharing interface.

After acquiring the predefined sharing interface, the video recording device may transmit the video data to a video sharing platform corresponding to the sharing interface.

It should be noted, the video recording device may also transmit the video data to a video sharing platform corresponding to the sharing interface after a confirmation of the user. Illustratively, the video recording device may establish a wireless or a wired connection with the user's terminal. After acquiring the video data, the video recording device may firstly transmit the video data to the user terminal, and a user may watch the video data on the user terminal and edits to the video data, then the user may select whether or not to transmit the video data to the video sharing platform.

It should be additionally noted that, according to the video recording method provided by the embodiments of the present disclosure, by starting video recording when an object around the video recording device is moving, the video recording device is capable of automatically starting to record the scene which the user wants to shoot.

In summary, according to the video recording method provided by embodiments of the present disclosure, by detecting whether the environmental information on the video recording device satisfies a predefined condition, and starting to record a video if the environmental information satisfies the predefined condition, the problem of troublesome video recording process existed in the related art is solved, and the video recording process is simpler and more convenient.

In addition, the embodiment shown in FIG. 2, the embodiment shown in FIG. 3, and the embodiment shown in FIG. 4 may be combined in implementation. That is, the video recording device may synthetically consider environmental information including the sound volume and voiceprint data involved in the embodiment shown in FIG. 2, the image information and the head feature involved in the embodiment shown in FIG. 3, and the position information and the light intensity involved in the embodiment shown in FIG. 4, so as to decide whether or not to start video recording. Illustratively, the video recording device may acquire all the above environmental information, and start to record a video when a predetermined number of the environmental information satisfies the predefined condition.

Embodiments of devices of the present disclosure are described hereinafter, which may be used for performing embodiments of methods of the present disclosure. For the details not described in the embodiments of devices of the present disclosure, please refer to the embodiments of methods of the present disclosure.

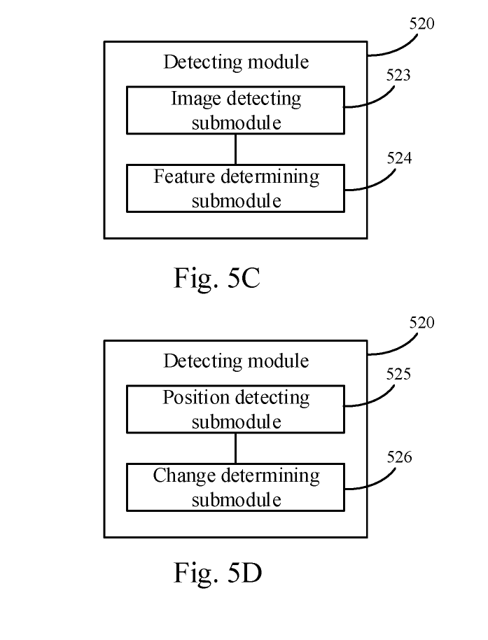

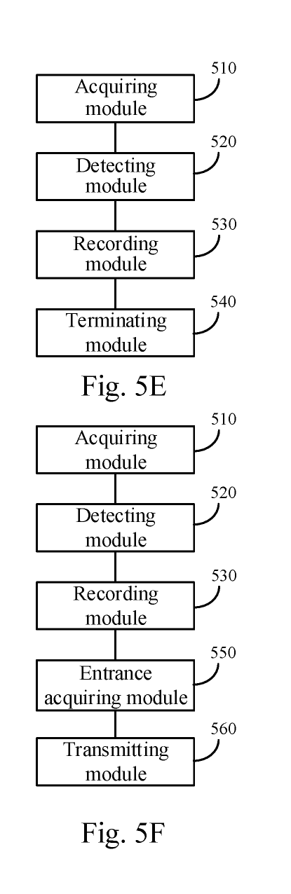

FIG. 5A is a block diagram of a video recording device according to one exemplary embodiment of the present disclosure. The video recording device may be used to record a video. The video recording device may include an acquiring module 510, a detecting module 520 and a recording module 530.

The acquiring module 510 is configured to acquire environmental information on a video recording device, and the environmental information is used for representing an environmental feature of the video recording device.

The detecting module 520 is configured to detect whether the environmental information satisfies a predefined condition.

The recording module 530 is configured to start video recording if the environmental information satisfies the predefined condition.

In summary, by detecting whether the environmental information on the video recording device satisfies a predefined condition, and starting to record a video if the environmental information satisfies the predefined condition, the video recording device provided by embodiments of the present disclosure solves the problem in the related art that the video recording device needs to be operated manually by a user to record a video and the problem of troublesome video recording process are solved, and achieves the effect that the video may be recorded without manual operation of the user and the effect the video recording process is simpler and more convenient.

Alternatively, the environmental information includes sound information.

As shown in FIG. 5B, the detecting module 520 includes a volume detecting submodule 521 and a threshold determining submodule 522.

The volume detecting submodule 521 is configured to detect whether a sound volume indicated by the sound information is greater than a volume threshold.

The threshold determining submodule 522 is configured to, if the sound volume is greater than the volume threshold, determine that the environmental information satisfies the predefined condition.

Alternatively, the threshold determining submodule 522 is configured to, if the sound volume is greater than the volume threshold, detect whether the sound information includes predefined voiceprint data; and if the sound information includes the predefined voiceprint data, determine that the environmental information satisfies the predefined condition.

Alternatively, the environmental information includes image information.

As shown in FIG. 5C, the detecting module 520 includes an image detecting submodule 523 and a feature determining submodule 524.

The image detecting submodule 523 is configured to detect whether the image information includes a head feature.

The feature determining submodule 524 is configured to, if the image information includes the head feature, determine that the environmental information satisfies the predefined condition.

Alternatively, the feature determining submodule is configured to, if the image information includes the head feature, detect whether the head feature is a predefined head feature; and if the head feature is the predefined head feature, determine that the environmental information satisfies the predefined condition.

Alternatively, the environmental information includes at least one piece of position information, and each piece of the position information includes information on position relative to the video recording device for any object around the video recording device in a predefined time period.

As shown in FIG. 5D, the detecting module includes a position detecting submodule 525 and a change determining submodule 526.

The position detecting submodule 525 is configured to detect whether there is a piece of changed position information among the at least one piece of position information.

The change determining submodule 526 is configured to, if there is a piece of changed position information among the at least one piece of position information, determine that the environmental information satisfies the predefined condition.

Alternatively, the environmental information further includes a light intensity.

The change determining submodule 526 is configured to, if there is a piece of changed position information among the at least one piece of position information, detect whether the light intensity is within a predefined light intensity range; and if the light intensity is within the predefined light intensity range, determine that the environmental information satisfies the predefined condition.

Alternatively, as shown in FIG. 5E, the device further includes a terminating module 540.

The terminating module 540 is configured to, after a predefined time interval when the environmental information fails to satisfy the predefined condition, terminate the video recording and obtain the recorded video data.

Alternatively, as shown in FIG. 5F, the device further includes an interface acquiring module 550 and a transmitting module 560.

The interface acquiring module 550 is configured to acquire a predefined sharing interface.

The transmitting module 560 is configured to transmit the video data to a video sharing platform corresponding to the sharing interface via the sharing interface.

It should be additionally noted that, the video recording device provided by the embodiments of the present disclosure starts video recording when a sound volume is greater than a volume threshold. Thus, the video recording device is capable of automatically starting to record the scene which the user wants to shoot.

It should be additionally noted that, the video recording device provided by the embodiments of the present disclosure starts video recording when the image information includes the head feature. Thus, the video recording device is capable of automatically starting to record the scene which the user wants to shoot.

It should be additionally noted that, the video recording device provided by the embodiments of the present disclosure starts video recording when an object is moving around the video recording device. Thus, the video recording device is capable of automatically starting to record the scene which the user wants to shoot.

In summary, the video recording device provided by embodiments of the present disclosure, by detecting whether the environmental information on the video recording device satisfies a predefined condition, and starting video recording if the environmental information satisfies the predefined condition, the problem of troublesome video recording process existed in the related art is solved, and the video recording process is simpler and more convenient.

With respect to the devices in the above embodiments, the specific manners for performing operations for individual modules therein have been described in detail in the embodiments corresponding to the methods, which will not be elaborated herein.

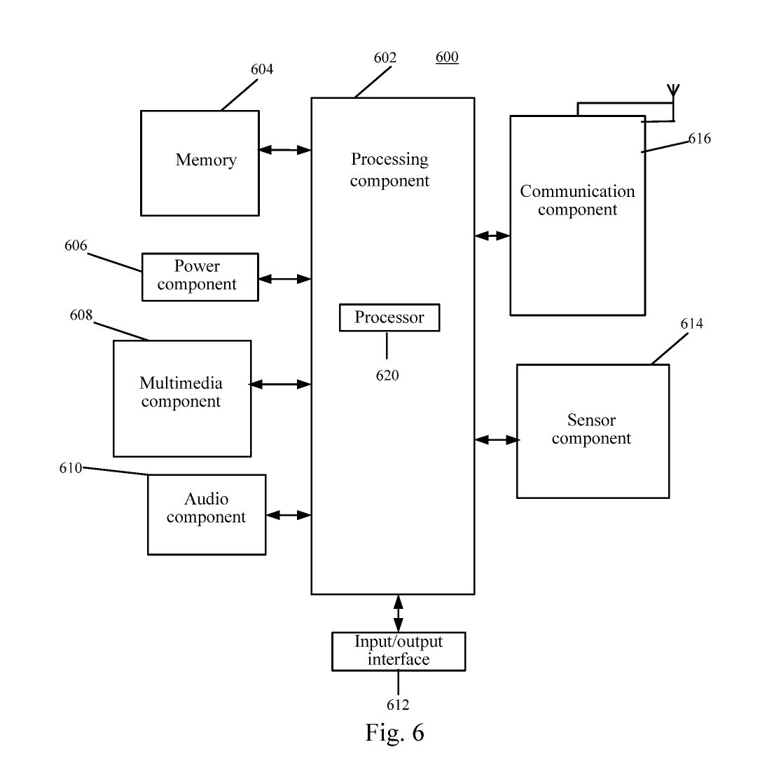

FIG. 6 is a block diagram of a video recording device 600, according to one exemplary embodiment of the present disclosure. For example, the device 600 may be a mobile phone, a computer, a digital broadcast terminal, a messaging device, a routing device, a gaming console, a tablet, a medical device, exercise equipment, a personal digital assistant, and the like.

Referring to FIG. 6, the device 600 may include one or more of the following components: a processing component 602, a memory 604, a power component 606, a multimedia component 608, an audio component 610, an input/output (I/O) interface 612, a sensor component 614, and a communication component 616.

The processing component 602 typically controls overall operations of the device 600, such as the operations associated with display, telephone calls, data communications, camera operations, and recording operations. The processing component 602 may include one or more processors 620 to execute instructions to perform all or part of the steps in the above described methods. Moreover, the processing component 602 may include one or more modules which facilitate the interaction between the processing component 602 and other components. For instance, the processing component 602 may include a multimedia module to facilitate the interaction between the multimedia component 608 and the processing component 602.

The memory 604 is configured to store various types of data to support the operation of the device 600. Examples of such data include instructions for any applications or methods operated on the device 600, contact data, phonebook data, messages, pictures, video, etc. The memory 604 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 606 provides power to various components of the device 600. The power component 606 may include a power management system, one or more power sources, and any other components associated with the generation, management, and distribution of power in the device 600.

The multimedia component 608 includes a screen providing an output interface between the device 600 and the user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action. In some embodiments, the multimedia component 608 includes a front camera and/or a rear camera. The front camera and/or the rear camera may receive an external multimedia datum while the device 600 is in an operation mode, such as a photographing mode or a video mode. Each of the front camera and the rear camera may be a fixed optical lens system or have focus and optical zoom capability.

The audio component 610 is configured to output and/or input audio signals. For example, the audio component 610 includes a microphone (“MIC”) configured to receive an external audio signal when the device 600 is in an operation mode, such as a call mode, a recording mode, and a voice recognition mode. The received audio signal may be further stored in the memory 604 or transmitted via the communication component 616. In some embodiments, the audio component 610 further includes a speaker to output audio signals.

The I/O interface 612 provides an interface between the processing component 602 and peripheral interface modules, such as a keyboard, a click wheel, buttons, and the like. The buttons may include, but are not limited to, a home button, a volume button, a starting button, and a locking button.

The sensor component 614 includes one or more sensors to provide status assessments of various aspects of the device 600. For instance, the sensor component 614 may detect an open/closed status of the device 600, relative positioning of components, e.g., the display and the keypad, of the device 600, a change in position of the device 600 or a component of the device 600, a presence or absence of user contact with the device 600, an orientation or an acceleration/deceleration of the device 600, and a change in temperature of the device 600. The sensor component 614 may include a proximity sensor configured to detect the presence of nearby objects without any physical contact. The sensor component 614 may also include a light sensor, such as a CMOS or CCD image sensor, for use in imaging applications. In some embodiments, the sensor component 614 may also include an accelerometer sensor, a gyroscope sensor, a magnetic sensor, a pressure sensor, or a temperature sensor.

The communication component 616 is configured to facilitate communication, wired or wirelessly, between the device 600 and other devices. The device 600 can access a wireless network based on a communication standard, such as WiFi, 2G, or 3G, or a combination thereof. In one exemplary embodiment, the communication component 616 receives a broadcast signal or broadcast associated information from an external broadcast management system via a broadcast channel. In one exemplary embodiment, the communication component 616 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In exemplary embodiments, the device 600 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods.

In exemplary embodiments, there is also provided a non-transitory computer readable storage medium including instructions, such as included in the memory 604, executable by the processor 620 in the device 600, for performing the above-described methods. For example, the non-transitory computer-readable storage medium may be a ROM, a RAM, a CD-ROM, a magnetic tape, a floppy disc, an optical data storage device, and the like.

A non-transitory computer readable storage medium, when instructions in the storage medium is executed by the processor of the device 600, enables the device to perform the video recording method provided by the above-mentioned individual embodiments.

Other embodiments of the invention will be apparent to those skilled in the art from consideration of the specification and practice of the invention disclosed here. This application is intended to cover any variations, uses, or adaptations of the invention following the general principles thereof and including such departures from the present disclosure as come within known or customary practice in the art. It is intended that the specification and examples be considered as exemplary only, with a true scope and spirit of the invention being indicated by the following claims.

It will be appreciated that the present invention is not limited to the exact construction that has been described above and illustrated in the accompanying drawings, and that various modifications and changes can be made without departing from the scope thereof. It is intended that the scope of the invention only be limited by the appended claims.

What is claimed is:

1. A video recording method, comprising:
acquiring environmental information on a video recording device, the environmental information being used for representing an environmental feature of the video recording device;
detecting whether the environmental information satisfies a predefined condition; and
if the environmental information satisfies the predefined condition, starting video recording.

2. The method according to claim 1, wherein the environmental information includes sound information, and
detecting whether the environmental information satisfies the predefined condition comprises:
detecting whether a sound volume indicated by the sound information is greater than a volume threshold; and
if the sound volume is greater than the volume threshold, determining that the environmental information satisfies the predefined condition.

3. The method according to claim 2, wherein determining that the environmental information satisfies the predefined condition if the sound volume is greater than the volume threshold comprises:
if the sound volume is greater than the volume threshold, detecting whether the sound information includes predefined voiceprint data; and
if the sound information includes the predefined voiceprint data, determining that the environmental information satisfies the predefined condition.

4. The method according to claim 1, wherein the environmental information includes image information, and
detecting whether the environmental information satisfies the predefined condition comprises:
detecting whether the image information includes a head feature; and
if the image information includes the head feature, determining that the environmental information satisfies the predefined condition.

5. The method according to claim 4, wherein determining that the environmental information satisfies the predefined condition if the image information includes the head feature comprises:
if the image information includes the head feature, detecting whether the head feature is a predefined head feature; and
if the head feature is the predefined head feature, determining that the environmental information satisfies the predefined condition.

6. The method according to claim 1, wherein the environmental information includes at least one piece of position information, each piece of the position information including information on position relative to the video recording device for any object around the video recording device in a predefined time period, and
detecting whether the environmental information satisfies the predefined condition comprises:
detecting whether there is a piece of changed position information among the at least one piece of position information; and
if there is a piece of changed position information among the at least one piece of position information, determining that the environmental information satisfies the predefined condition.

7. The method according to claim 6, wherein the environmental information further includes a light intensity, and
determining that the environmental information satisfies the predefined condition if there is a piece of changed position information among the at least one piece of position information comprises:
if there is a piece of changed position information among the at least one piece of position information, detecting whether the light intensity is within a predefined light intensity range; and
if the light intensity is within the predefined light intensity range, determining that the environmental information satisfies the predefined condition.

8. The method according to claim 1, further comprising:
after a predefined time interval when the environmental information fails to satisfy the predefined condition, terminating the video recording and obtaining recorded video data.

9. The method according to claim 8, further comprising:
acquiring a predefined sharing interface; and
transmitting the video data to a video sharing platform corresponding to the sharing interface via the sharing interface.

10. A video recording device, comprising:
a processor; and
a memory for storing instructions executable by the processor;
wherein the processor is configured to perform:
acquiring environmental information on the video recording device, the environmental information being used for representing an environmental feature of the video recording device;
detecting whether the environmental information satisfies a predefined condition; and
if the environmental information satisfies the predefined condition, starting video recording.

11. The device according to claim 10, wherein the environmental information includes sound information, and
the processor is further configured to perform:
detecting whether a sound volume indicated by the sound information is greater than a volume threshold; and
if the sound volume is greater than the volume threshold, determining that the environmental information satisfies the predefined condition.

12. The device according to claim 11, wherein the processor is further configured to perform:
if the sound volume is greater than the volume threshold, detecting whether the sound information includes predefined voiceprint data; and
if the sound information includes the predefined voiceprint data, determining that the environmental information satisfies the predefined condition.

13. The device according to claim 10, wherein the environmental information includes image information, and
the processor is further configured to perform:
detecting whether the image information includes a head feature; and
if the image information includes the head feature, determining that the environmental information satisfies the predefined condition.

14. The device according to claim 13, wherein the processor is further configured to perform:
if the image information includes the head feature, detecting whether the head feature is a predefined head feature; and
if the head feature is the predefined head feature, determining that the environmental information satisfies the predefined condition.

15. The device according to claim 10, wherein the environmental information includes at least one piece of position information, each piece of the position information including information on position relative to the video recording device for any object around the video recording device in a predefined time period, and
the processor is further configured to perform:
detecting whether there is a piece of changed position information among the at least one piece of position information, and
if there is a piece of changed position information among the at least one piece of position information, determining that the environmental information satisfies the predefined condition.

16. The device according to claim 15, wherein the environmental information further includes a light intensity, and
the processor is further configured to perform:
if there is a piece of changed position information among the at least one piece of position information, detecting whether the light intensity is within a predefined light intensity range; and
if the light intensity is within the predefined light intensity range, determining that the environmental information satisfies the predefined condition.

17. The device according to claim 10, wherein the processor is further configured to perform:
after a predefined time interval after acquiring the environmental information satisfying the predefined condition, terminating the video recording and obtaining the recorded video data.

18. The device according to claim 17, wherein the processor is further configured to perform:
acquiring a predefined sharing interface; and
transmitting the video data to a video sharing platform corresponding to the sharing interface via the sharing interface.

19. A non-transitory readable storage medium comprising instructions, executable by a processor in an electronic device, for performing a video recording method, the method comprising:
acquiring environmental information on a video recording device, the environmental information being used for representing an environmental feature of the video recording device;
detecting whether the environmental information satisfies a predefined condition; and
if the environmental information satisfies the predefined condition, starting video recording.
